(19) United States
(12) Patent Application Publication
(10) Pub. No.: US 2010/0241459 A1
(43) Pub. Date: Sep. 23, 2010

(54) SYSTEM AND METHOD FOR TRACKING CONSUMER HEALTHCARE BEHAVIOR

(76) Inventor: Y. Ramprasad Rao, Jersey City, NJ (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 12/772,529

(22) Filed: May 3, 2010

Related U.S. Application Data
(63) Continuation of application No. 11/393,102, filed on Mar. 30, 2006, now abandoned.
(60) Provisional application No. 60/666,443, filed on Mar. 30, 2005.

(51) Int. Cl. G06Q 10/00; G06Q 50/00

(52) U.S. Cl. 705/3; 705/10

(57) ABSTRACT

A method of tracking healthcare consumer purchase behavior and attitudes, ibncluding recruiting a panel of patients suffering from a medical condition; collecting data regarding attitudes and demographics of said patients; collecting data regarding purchase behavior of said patients; correlating said data regarding attitudes and demographics of said patients to said data regarding purchase behavior of said patients; and making one or more assessments regarding a future marketing strategy.

### CROSS-REFERENCE TO RELATED APPLICATION

This application is a continuation application of U.S. patent application Ser. No. 11/393,102 filed on Mar. 30, 2006, which claims the benefit of U.S. Provisional Patent Application No. 60/666,443, filed Mar. 30, 2005. The entire disclosure of U.S. patent application Ser. Nos. 11/393,102 and 60/666,443 are hereby incorporated herein by reference.

### FIELD OF THE INVENTION

The present invention relates generally to a methods for tracking consumer behavior and, more particularly, to systems and methods for ongoing tracking and analysis of consumer pharmaceutical transactions using point-of-sale data and consumer surveys.

### BACKGROUND OF THE INVENTION

Manufacturers often budget a significant amount of resources to market their products. They do so in order to increase the level of consumer recognition of their products as well as to achieve favorable impressions of the products, with the ultimate objective of increasing profits from sales.

However, an increase in consumer-recognition and favorable impressions of a product do not necessarily correspond to an increase in sales of the product. Many factors influence whether a consumer purchases and in turn uses a specific prescription product. These factors include the following: how consumers learn about their medical conditions; how consumers cope with their medical conditions; what situations drive consumers to consult their physicians; what consumers take away from consultations with their physicians; what drives a consumer's decision regarding whether or not to fill his/her prescription; what motivates pharmacists to recommend alternatives such as over-the-counter or generic products; and the impact of price or formulary placement on a consumer's usage decision.

Taken together, these factors have a strong impact on consumer or patient compliance and persistence. Specifically, once a consumer has filled a prescription, does he/she use it as directed (compliance)? Does he/she refill it as directed (persistence)? Many factors affect patients' compliance and persistence, including age, level of understanding of condition and treatment options, denial, complexity of the treatment regime, taking of other medication, adverse side effects, financial considerations, opinions of others, personal beliefs and demographics. Due, in part, to the interplay among these factors, the pharmaceutical industry has been plagued for decades by poor patient persistence and compliance. For example, while it is estimated that 70% to 80% of prescription medication sales are for chronically treated medical conditions, across a wide range of therapeutic classes, an astonishing 30% to 80% of patients who begin a drug therapy discontinue the therapy in six months or less.

Although physicians are the driving force for patients to initially begin the drug therapy, patients generally are responsible for the ongoing refills, which represent 80% or more of the course of the drug therapy. In total, it is estimated that the pharmaceutical industry suffers from $30 billion in lost sales annually from the failure of patients to continue their drug therapy.

To gain insight into consumer purchase behavior, i.e., to determine factors affecting whether and why consumers purchase certain products and not others, manufacturers often resort to the use of ad hoc, one-time surveys. An ad hoc, one-time survey of a patient may help a pharmaceutical company determine why a patient stopped taking a specific medicine at a specific point in time. Likewise, analysis of purchase data for a particular prescription medication may be used by a pharmaceutical company, at an aggregated level, to analyze, on average, how long the prescription medication was purchased by patients and when the level of such purchases changed. Prior to the present invention, no system for integrating patent attitudes and purchase behavior over an extended period of time was known or in use.

One-time surveys may be useful to determine patient motivations and attitudes at a specific point in time. Such surveys may be used to query consumers on factors such as brand recognition, favorable/unfavorable impressions, past purchases of the product, intended future purchases of the product and reasons for purchasing the product. These surveys, however, do not necessary reflect actual purchase behavior over time. That is, a consumer may answer that he/she purchased a particular prescription product in the past, but is uncertain as to how much was paid, what the dosage was, what exact brand and strength was purchased, or what the exact timing of the purchase was. Further, there is no certainty that consumers who partake in surveys eventually adhere to answers to questions regarding intended future purchases. Thus, for example, although a patient may have indicated in a survey that he/she currently is being treated for ulcers by using Prescription Medicine A and that he/she intends to refill the prescription, there is no certainty that the patient will not later opt to treat the ulcers by using a non-prescription (over-the-counter) product or by using another prescription medicine for treating ulcers.

Additionally, manufacturers may obtain a general idea of the percentage of consumers who purchase their products by analyzing consolidated cash-register claims data on prescription purchases from pharmacies. Information regarding the purchase behavior of patients may be obtained by gathering “de-identified” (i.e., anonymous) information from pharmacies on the age and sex of patients who purchase a particular medicine of interest, with the identity of the patients being maintained in privacy. Such information, however, is static in that it merely provides a view of purchase behavior at a particular point in time, with limited demographic information. That is, while such data provides some information regarding the patients who purchased the medicine of interest during a set time period, it does not provide insight into whether they eventually switch to a competing brand or even stop treatment altogether. Further, such information provides no indication regarding what caused the patient to make the initial purchase of the medicine or to discontinue its use.

Thus, consolidated claims data provides little insight regarding why the purchases were made or the demographics of the consumers. Further, such data provides no insight into what caused the initial purchase behavior and what caused changes in the purchase behavior.

As discussed above, a patient's purchase behavior may be assessed through the use of ad hoc one-time surveys containing questions regarding, for example, whether the patient recognizes the medicine of interest, whether the patient has purchased the medicine in the past and, if so, whether the patient intends to continue using the medicine. Although such surveys may indicate patients' attitude and intentions when the surveys were taken, they may not accurately reflect the patients' actual attitudes and intentions at the time of their actual purchase decisions.

Thus, there is a need for an improved method and system for tracking and analyzing pharmaceutical purchase behavior.

### SUMMARY OF THE INVENTION

Embodiments of the present invention satisfy this and other needs by providing a system for tracking consumer pharmaceutical-purchase behavior and attitudes longitudinally. The system measures patient attitudes and demographics via surveys and ties them to actual purchase behavior over time.

Embodiments of the invention are directed to a system and method tracking healthcare consumer purchase behavior and attitudes, including recruiting a panel of patients suffering from a medical condition, collecting data regarding attitudes and demographics of the patients, collecting data regarding purchase behavior of the patients, correlating the data regarding attitudes and demographics of the patients to the data regarding purchase behavior of the patients and making one or more assessments regarding future marketing strategy.

Embodiments of the invention provide for a system that obtains attitudinal data on patient compliance and persistence over an extended period of time without having to rely only on patients to accurately recall or predict their behavior.

Embodiments of the invention provide a system for correlations to be made between products purchased and both the panelist's attitudes and beliefs at the time of the purchase and the factors influencing those attitudes and beliefs.

Thus, embodiments of the present invention provide an improved method and system for tracking and analyzing pharmaceutical purchase behavior.

### BRIEF DESCRIPTION OF THE DRAWINGS

The present invention will be more readily understood from the detailed description of exemplary embodiments presented below considered in conjunction with the attached drawings, of which:

FIG. 1 is a schematic diagram an embodiment of the present invention;

FIG. 2 is a flow diagram of a method in accordance with an embodiment of the present invention; and

FIG. 3 is a flow diagram of an overview of an embodiment of the present invention.

It is to be understood that the attached drawings are for purposes of illustrating the concepts of the invention.

### DETAILED DESCRIPTION OF THE INVENTION

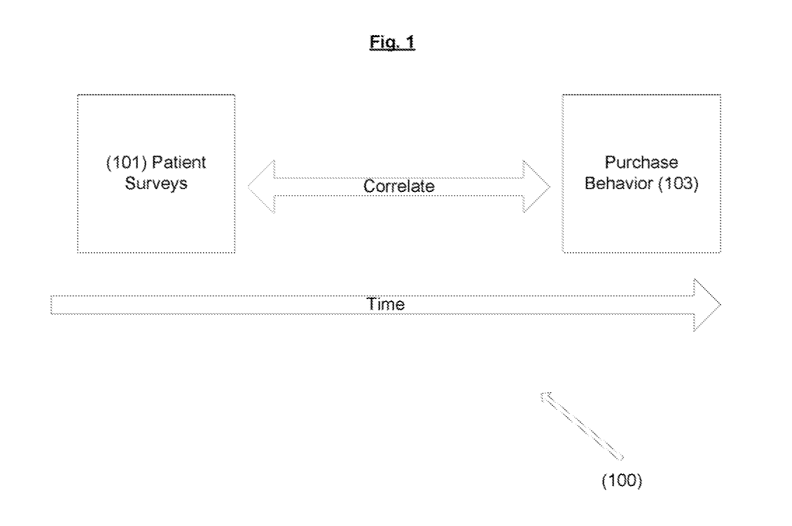

With reference to FIG. 1, embodiments of the present invention provide systems and methods for tracking consumer pharmaceutical purchase behavior and attitudes longitudinally, i.e., over an extended period of time (100). The systems and methods measure patient attitudes and demographics via surveys (101) and correlates them (102) to actual purchase behavior (103) over time.

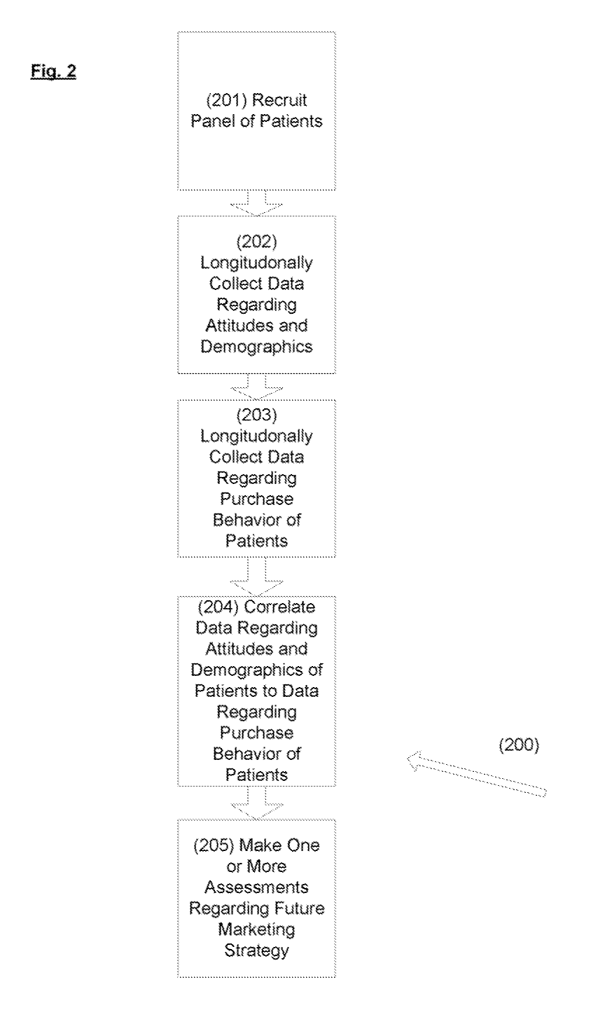

With reference to FIG. 2, in one embodiment of the invention (200), a panel of patients suffering from a medical condition is recruited (201), data regarding attitudes and demographics of the patients is collected (202), data regarding purchase behavior of the patients is collected (203), correlating the data regarding attitudes and demographics of the patients to the data regarding purchase behavior of the patients (204) and making one or more assessments regarding future marketing strategy (205).

In some embodiments, the system identifies drivers as well as barriers to adherent patient behavior, and thus provides insight into patient compliance and persistence with a prescribed course of drug therapy. That is, the system identifies reasons why patients continue taking a prescribed medicine (adherence), and also identifies reason why patients stop taking the prescribed medicine (non-adherence). The identified reasons for adherence and non-adherence are quantified, such that for each identified reason the volumetric impact of the reason on the actual utilization of the drug may be assessed. The knowledge obtained from identifying and quantifying the reasons for adherence/non-adherence is used to determine future courses of action for improving patient compliance and persistence. In an example of one of many applications of the system of some embodiments, the knowledge is segmented into messages that each address an identified reason for non-adherence. Based on demographic information obtained by the system, groups of patients are targeted with one or more of the messages to yield improvements in patient adherence to utilization of the drug.

Unlike the conventional survey techniques discussed above, embodiments of the system of the present invention can obtain attitudinal data on patient compliance and persistence over an extended period of time (two months or greater) without having to rely only on patients to accurately recall or predict their behavior. The system provides insight into why patients adhere to, or do not adhere to, a prescribed course of drug therapy by linking longitudinal patient attitudinal data, obtained from surveys, with pharmacy claims data. Additionally, some of the embodiments can provide insight into the demographics and attitudes of who adheres to and who does not adhere to a prescribed course of drug therapy. In an example of one of many applications of the embodiments of the present invention, from the obtained “why” and “who” data, predictive modeling techniques are used to create appropriately tailored messages targeted for selected population groups to increase the number of patients who adhere.

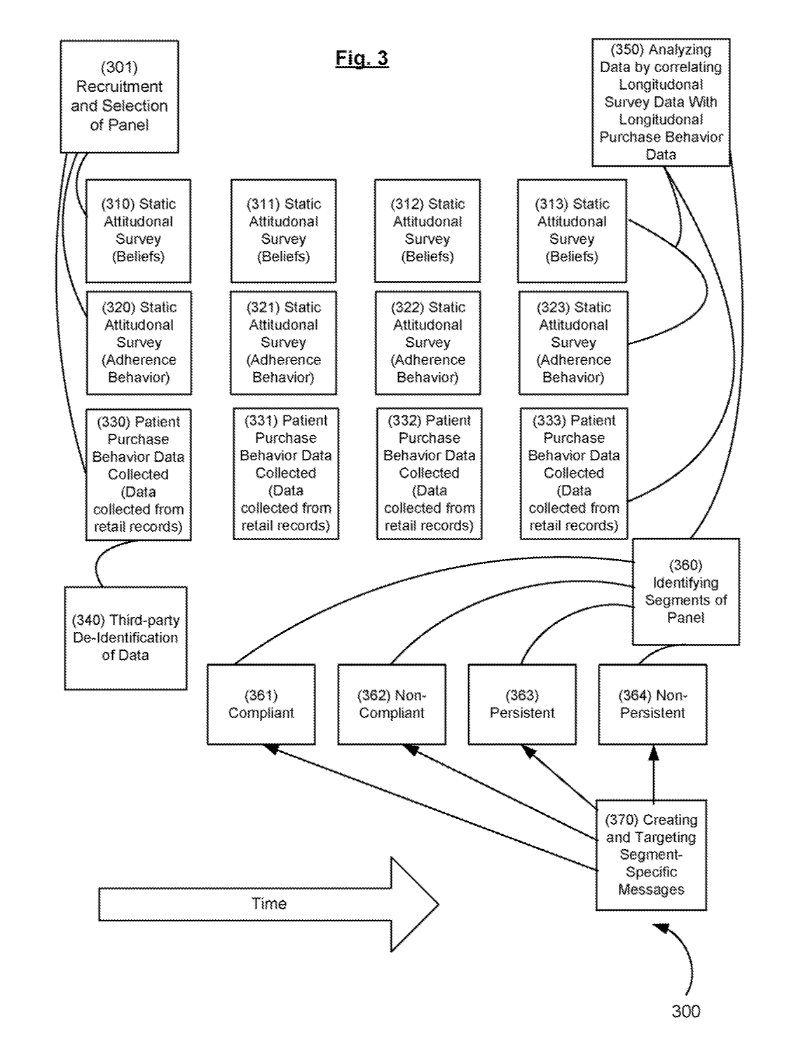

With reference to FIG. 3, according to an embodiment of the present method of tracking and analyzing consumer attitudes and purchase behavior (300), a panel or group of consumers who consent to being tracked is assembled (301). A panel includes a statistically significant number of panelists. For each panelist, information is gathered on his/her actual purchases by obtaining data from retailers based on the panelist's identifying information. The identifying information may include, but is not be limited to, the following: name, sex, date of birth, address, telephone number, etc. The purchase information is gathered routinely, i.e., on multiple occasions, over a period of time, so that changes in a panelist's purchase behavior may be determined. Each panelist's purchase behavior also is tracked through the use of surveys, which ask questions designed to obtain insight into the factors that affect the panelist's attitude toward the product being studied. Such factors include, but are not limited to, news reports, advertisements, word of mouth, comments from doctors, comments from pharmacists, cost, ease of use and the availability of equivalents. Further, the surveys may include questions regarding the panelist's life, such as questions about medical conditions, emotional well-being, diet, exercise, financial situation, marital status, family, recreational pastimes, severity of symptoms and side effects.

In addition to the surveys, an analysis can be made of the panelists' purchase information in conjunction with survey results (350). This allows correlations to be made between the product(s) purchased and both the panelist's attitudes and beliefs at the time of the purchase and the factors influencing those attitudes and beliefs. The factors influencing attitudes may include, but are not limited to, family, work, finances, social status and medical status. This is considered a static analysis in that it provides a snapshot of the panel's purchase behavior at that time. By both routinely surveying the panelists and obtaining their purchase information on multiple occasions over the course of weeks or months or years, a longitudinal analysis is possible. Specifically, correlations may be made between changes in the panel's attitudes and changes in its purchase behavior.

For example, the purchase data for a given period may show that some of the panelists switched from a brand-name medicine to a generic equivalent. Survey results for this period may show that some of the panelists' health-insurance coverage changed, thus indicating a possible reason for the switch.

By way of another example, the purchase data may show that some of the panelists switched from Brand A to Brand B at about the same time that a large marketing campaign for Brand B was launched. The survey results may give some insight into the effect of the marketing campaign on the panelists.

With respect to sample size, a panel preferably comprises 6000 members or more. Such large sample sizes allow for granular analysis of patient behavior. That is, large sample sizes allow for the identification of sub-groups of patients with common behavior patterns. Panels may comprise individuals suffering from a common medical condition or individuals undergoing a common drug therapy. Alternatively, panels of more or less than 6,000 members can be used, as would be determined by one of skill in the art, as informed by the present disclosure.

The panel may be recruited by any known method, including by advertisements on radio, television, Internet web sites and printed publications. Panelists may also be recruited by e-mail, telephone or in person. Panelists may be recruited by any combination of these methods as well. In order to encourage an individual to become a panelist, incentives may be offered. For example, an advertisement may indicate that persons who currently suffer from ulcers are invited to join in a marketing-related survey, that all interested persons who apply to join the panel will be given a gift certificate having a certain value, and/or that those selected to be in the panel will be eligible for more gift certificates. As incentive for continued participation on the panel, an advertisement may indicate that the values of gift certificates awarded will increase with each survey completed. Of course, other types of incentives may be used.

Before an individual is selected to be a panelist, information supplied by the individual can be checked to verify his/her identity. As mentioned above, in some embodiments, in order to be a panelist, an individual must consent to having his/her purchase behavior monitored.

According to an aspect of the invention, the purchase information of each panelist is obtained on an on-going basis from retail records such as cash-register receipts and pharmacy prescription purchase records (330)-(333). In accordance with the requirements of the Health Insurance Portability and Accountability Act (“HIPPA”), panelists' survey data and claims data are matched by a third-party prior to de-identification (340). De-identification is the process by which any link between particular purchases and the identity of particular panelists is concealed. Thus, information regarding specific purchase(s) made by an individual panelist cannot be traced back to the panelist. In this way, the system of the present invention meets requirements of HIPAA, which requires that individual pharmacy records be confidential.

According to another aspect of the invention, panelists are requested to answer two types of attitudinal surveys. In the first type, each panelist is asked on a periodic, ongoing basis general attitudinal questions regarding, among other things, their beliefs about and understanding of the medical ailment suffered by the panelist; the treatments available; and the risks/benefits of the available treatments (310)-(313). In the second type, each panelist is asked on an ongoing, periodic basis, specific attitudinal questions regarding the panelist's adherence behavior with respect to a particular treatment (320)-(323). The second type of attitudinal survey may be given on a monthly basis, for example, and asks the panelist to provide one or more reasons for his/her adherence behavior. He surveys can be given at regular or irregular intervals of time.

This two-pronged approach to surveying panelists is designed to uncover a more complete and true understanding of the barriers to and drivers of adherent patient behavior. The first type of attitudinal survey captures and associates with actual patient behavior specific attitudes that patients often find difficult to articulate and/or admit about their actual behavior. The second type of attitudinal survey captures the attitude of a panelist close to when that behavior occurred. As such, the second type of attitudinal survey provides situational insight into the panelist's behavior at a known point in time, and minimizes the inherent biases of survey results that rely on an accurate recall of past attitudes and behavior. Additionally, because of its periodic nature, this approach also tracks changes in the panelist's attitudes and behavior over the course of the treatment and the progression of the ailment.

According to an aspect of the invention, each panelist can be surveyed to obtain information on any or all of the following:
Beliefs about and understanding of the risks that his/her medical condition puts them in;
Beliefs about and understanding of the medically prescribed drug therapies used to treat the medical condition;
The severity of the panelist's suffering, as well as the panelist's comorbidities (i.e., presence of one or more disorders in addition to a primary disease or disorder and/or the effect of such additional disorders, or disease) and concomitant therapies;
The panelist's opinion of the efficacy, side effects, dosage, convenience, and cost of the prescribed drug
Quality and nature of the panelist's interactions with his/her physician, as well as the level of education of the panelist regarding the medical condition (through self-education as well as physician-provided information);
The panelist's reasons for consulting a physician, which led to the diagnosis of the medical condition and its treatment using the prescribed drug;
If applicable, the panelist's reasons for non-compliance or discontinuance of the drug therapy;
The effectiveness of “direct-to-consumer” (DTC) advertising campaigns and promotional strategies;
The panelist's media consumption and media preferences;
The panelist's health insurance coverage and prescription-drug benefits; and
The panelist's demographics, psychographies and lifestyle.

Embodiments of the present invention enable the integration of patient attitudes with patient prescription-purchase behavior over an extended period of time. Using specific longitudinal panels for specific ailments or medical conditions, the present invention enables patient attitudes to be matched (through the use of periodic surveys) with patient prescription-purchasing behavior (through the use of a third-party data provider) over an extended period of time.

Additionally, the integration of attitude and behavioral data provided by the present invention enables numerous different applications of the system. For example, the large quantities of longitudinal data collected through the surveys may be analyzed using many techniques, including but not limited to, clustering techniques, which utilize market-segmentation and predictive-modeling methodologies, as are known to those of skill in the art, to distill actionable insights into how to improve a typical patient's adherence to a drug treatment. In this example, clustering techniques are used to segment compliant and non-compliant panelists and persistent and non-persistent panelists (360)-(364), and factor-analysis techniques are used to distill the key attitudinal drivers/barriers underlying the behavior of a typical patient within a particular segment. Predictive-scoring modeling techniques are used to determine the demographics of the segment of panelists with the highest tendency to be adherent to a prescribed treatment, so that marketing strategies may be specifically developed to influence the continued adherence of other patients with similar demographics. Similarly, the predictive scoring modeling techniques are used to determine the demographics of the segment of panelists with a low level of adherence, so that marketing strategies may be specifically designed to address common reasons for non-adherence and thus increase the level of adherence of other demographically similar patients (370). Additionally, for an identified segment of panelists with a known adherence tendency, marketing strategies may be developed to target other patients of similar demographics to address identified issues affecting their adherence, in order to increase their adherence to a prescribed drug therapy.

Thus embodiments of the present invention provide a system and method of tracking both healthcare consumer attitudes and healthcare consumer purchase data and correlating the two. Thus, by way of the embodiments of the present invention, a user can create and direct segmented marketing messages to healthcare consumers and, thereby, increase profits from selected drug therapy products.

Embodiments of the present invention can be implemented via telephone, in person or via a computer software program or programs resident on one or more computers, processors, and/or servers. Embodiments of the invention can be implemented at a standalone computer, or as part of a distributed system, with computers being communicatively coupled via a network, such as an intranet, the Internet, or a combination of both, as would be a matter of application-specific design choice for one skilled in the art, as informed by the present application.

In addition, while embodiments of the invention have been described by way of having certain steps, embodiments of the invention can also include methods whereby certain of the steps are omitted, performed in a different sequence than that of the provided examples, certain of the steps are performed concurrently, and/or certain of the steps are performed more than once. Further, the steps of the embodiments of the invention may be automated, performed manually, or be a combination of both automated and manual steps.

It is to be understood that the exemplary embodiments are merely illustrative of the invention and that many variations of the above-described embodiments can be devised by one skilled in the art without departing from the scope of the invention. It is therefore intended that all such variations be included within the scope of the following claims and their equivalents.

What is claimed is:

1. A method of tracking healthcare consumer purchase behavior and attitudes, comprising:
recruiting a panel of patients suffering from a medical condition;
collecting data regarding attitudes and demographics of said patients;
collecting data regarding purchase behavior of said patients;
correlating said data regarding attitudes and demographics of said patients to said data regarding purchase behavior of said patients; and
making one or more assessments regarding a future marketing strategy.

2. The method of claim 1, wherein the data regarding attitudes and demographics of said patients is collected by means of surveys.

3. The method of claim 1, wherein the correlating is accomplished by employing identifying information.

4. The method of claim 3, wherein the identifying information includes one or more of the panelist's name; the panelist's gender; the panelist's date of birth; the panelist's address;
and the panelist's telephone number.

5. The method of claim 2, wherein the surveys are conducted at more than one point in time.

6. The method of claim 5, wherein the surveys include personal questions regarding the patient.

7. The method of claim 6, wherein the personal questions relate to one or more of medical conditions; emotional well-being; diet; exercise habits; finances; marital status; family dynamics; and recreational preferences.

8. The method of claim 1, wherein the data regarding patient purchase behavior includes retail sales records.

9. The method of claim 8, wherein the retail sales records are pharmacy retail sales records.

10. The method of claim 8, wherein the retail sales records are de-identified, whereby specific purchases made by a patient cannot be traced back to the patient.

11. The method of claim 8, wherein the retail sales records are collected at more than one point in time.

12. The method of claim 1, wherein the assessments include determining a future course of action for improving patient compliance and persistence.

13. The method of claim 12, wherein the course of action include creating segmented messages that each address an identified reason for non-compliance.

14. The method of claim 12, wherein the course of action include creating segmented messages that each address an identified reason for non-persistence.

15. The method of claim 2, wherein the surveys contain questions designed to obtain insight into factors affecting the panelist's attitude toward a product being studied.

16. The method of claim 15, wherein the factors include one or more of news reports; advertisements; word of mouth; comments from physicians; comments from pharmacists; cost, ease of use; and availability of equivalents.

17. The method of claim 15, wherein the product being studied is a drug therapy.

18. The method of claim 1, wherein said panel is recruited by use of advertisements.

19. The method of claim 18, wherein the advertisements are one of more of television advertisements; radio advertisements; and Internet advertisements.

20. The method of claim 18, wherein the advertisements include offerings of incentives.

21. The method of claim 1, wherein the panel is recruited by means of direct solicitation.

22. The method of claim 21, wherein the direct solicitation includes the offering of incentives.

23. The method of claim 2, wherein each patient is asked questions regarding the patient's beliefs about the medical condition.

24. The method of claim 2, wherein each patient is asked questions regarding the patient's beliefs about treatments available for the medical condition.

25. The method of claim 2, wherein each patient is asked questions regarding the patient's specific adherence behavior with respect to a particular treatment.

26. The method of claim 12, wherein the courses of action include segmenting compliant and non-compliant patients.

27. The method of claim 12, wherein the courses of action include segmenting persistent and non-persistent patients.

28. The method of claim 12, wherein the courses of action include developing marketing strategies specifically designed to influence the continued adherence of patients with demographics similar to those patients with the highest tendency to be adherent to a prescribed treatment.

29. The method of claim 26, wherein the segmenting is accomplished by using predictive-scoring modeling techniques to determine the demographics of patients with the highest tendency to be compliant with respect to a prescribed treatment.

30. The method of claim 27, wherein the wherein the segmenting is accomplished by using predictive-scoring modeling techniques to determine the demographics of patients with the highest tendency to be persistent with respect to a prescribed treatment.

31. A system for tracking healthcare consumer purchase behavior and attitudes, comprising one or more processors programmed and configured for:
receiving data regarding attitudes and demographics of a panel of patients suffering from a medical condition;
receiving data regarding purchase behavior of said patients;
correlating said data regarding attitudes and demographics of said patients to said data regarding purchase behavior of said patients; and
making one or more assessments regarding a future marketing strategy.

32. The system of claim 31, wherein the data regarding attitudes and demographics of said patients is collected by means of computerized surveys.

33. The system of claim 32, wherein the surveys are conducted at more than one point in time.

34. The system of claim 31, wherein the data regarding patient purchase behavior includes retail sales records.

35. The system of claim 34, wherein the retail sales records are collected at more than one point in time
